(19) United States
(12) Patent Application Publication
(10) Pub. No.: US 2007/0209410 A1
(43) Pub. Date: Sep. 13, 2007

(54) Lock for a tree stand

(76) Inventor: Shane Ashley Clum, Cedar Springs, MI (US)

Correspondence Address: CHRISTOPHER D. HARRINGTON, SUITE 350, 5300 CORPORATE GROVE DR SE, GRAND RAPIDS, MI, 49512, US

(21) Appl. No.: 11/372,794

(22) Filed: Mar. 10, 2006

(51) Int. Cl. E05B 65/36; E05B 63/14

(52) U.S. Cl. 70/262

(57) ABSTRACT

A novel lock for a tree stand for use in hunting and similar pursuits comprises a hardened metal loop for encircling the body of a tree, where the metal loop is retainable to brackets integrally attached to a tree stand. The tree stand lock further includes lockable hardened ends on said metal loop for retaining the metal loop to the brackets. The hardened metal loop is pivotable about a pivot pin that is formed from a hardened metal and where the pivot pin opens and closes the loop for assisting in the installation and removal of the tree stand lock from a tree stand.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a lock for a tree stand. More particularly, the present invention relates to a locking device that will prevent the unauthorized removal of a tree mounted hunting stand from the tree to which it is attached.

Hunters are known to be resourceful people, the passion they generally have for their sport results in myriad products that are virtually all intended to provide that “edge” that will assist them in getting their kill. Hunters who target bigger game animals, like deer, elk and the like, confront challenges that are considered to be greater than for smaller game animals since their targets are much more wary and are difficult to approach. In many cases these hunters will use tree stands to hunt from since the elevated platform provides a desirable position to shoot from and it tends to keep the hunter out of the line of vision of the subject game animal.

Tree stands are very well known in the field of hunting sport with many different designs being offered. Generally speaking, the tree stand will comprise a seat portion and a base portion which might or might not be interconnected. Both the base and the seat portions are, however, attachable to a tree trunk at some point well above ground level. The attachment may comprise a number of possible methods, such as wire cable, or nylon straps, or chains. Obviously the method of attachment takes into the consideration the need to encircle the tree trunk while retaining the base and seat portions of the tree stand and also to accommodate the weight of the tree stand and the hunter. The methods selected by those associated with the manufacture of tree stands have been successful and tree stands have enjoyed a great deal of popularity amongst hunters.

In some parts of the country tree stand usage has become so commonplace that during the hunting season it is possible for one to find tree stands installed in position in many forests. Hunters will preferably deploy their tree stands in advance not only to eliminate the lost time in having to put the tree stand up and to take it down for each day of hunting, but the main reason the tree stands are left in place is to avoid making noise or movements that might be detected by the subject game animal. With the tree stand in place the hunter is free to make his/her way to the location of the tree stand as stealthy as possible and then climb up and onto the tree stand to take his/her position. Obviously, if the tree stand were to be removed daily, it could greatly interfere with the hunter's success, obviating the benefits of the tree stand altogether.

This practice of leaving tree stands in place is widely accepted although in state and federal forest areas there may be posted prohibitions warning the hunters not to leave their equipment in place. Even in this circumstance many hunters will still continue to leave the tree stand in place, which is evidence more of their passionate commitment o bag their desired game animal than an outright disrespect for the law. Nonetheless, where permitted, whether on government or privately controlled lands, the typical large game hunter is very likely going to leave his necessary tree stand in place. Thus when he/she is not hunting, the tree stand is left unattended which presents some problems. The first one is the fact that in some areas, it is possible that conservation officers or other enforcement agents may take it upon themselves to remove unattended tree stands. Whether or not there are legal prohibitions against unattended tree stands, the hunter is left with the dilemma of sorting out what happened to the tree stand and thereafter attempting to affect a recovery of his/her property. Secondly, the popularity of tree stands is well known and it happens, with some frequency, that other hunters will steal unattended tree stands at times. In some cases this represents a loss of hundreds of dollars worth of investment which only adds to the frustration of not being able to use the tree stand as planned.

Examples of tree stands of the type associated with the present invention may be found in U.S. Pat. No. 4,667,773 (Davis) and U.S. Pat. No. 6,715,585 (Overbaugh). The seat portion and base portion of the tree stands are shown and the approach for mounting onto the tree is typical of such devices in general although these references illustrate merely two ways of practicing a tree stand and it is understood that many additional design approaches are known in the art.

Similarly, there have been attempts in the prior art to provide for anti-theft properties in a tree stand. Some examples include U.S. Pat. No. 6,390,239 (McClain) where a tree stand is secured by using a bracket that fits over the support for the tree stand construction and where the bracket can be screwed into the tree trunk with a large wood screw. Access to the wood screw is prevented by a locking body that fits into a chamber housing the wood screw thereby blocking access to the screw head. In U.S. Pat. No. 4,936,416 (Garon) a tree stand is fastened to a tree trunk through the use of a wire cable that can be affixed to the tree stand and tightened using a turnbuckle. One end of the cable includes a hasp arrangement that allows the cable to be padlocked to discourage removal.

Other approaches to inhibit the unauthorized removal of tree stands are known in the art, however, the reality in the field is that many if not all of these devices are being defeated through the use of sophisticated techniques that are employed by thieves. In particular, bolt cutters have been used to cut through chains and cables, composite disc grinders (cordless) have been used to slice through high strength cable and padlocks, and it would not be out of the realm of possibilities that portable torches have been used to cut off securing devices in order to steal a tree stand. The point is that commonly used approaches are routinely being defeated because of the combination of tenacity and resourcefulness on the part of the thieves who are engaged in this activity. It has therefore become an ever increasing problem to find a way to protect a hunter's tree stand from theft.

The present invention provides protection for a tree stand with a lockable security system. The tree stand lock of the present invention is resistant to many of the methods that persons have used to circumvent the tree stand locks known in the prior art. The features and benefits of the present invention will be discussed in more detail herein.

### SUMMARY OF THE INVENTION

A novel tree stand lock comprises a hardened metal loop for encircling the body of a tree, where the metal loop is retainable to brackets integrally attached to a tree stand, and lockable hardened ends on said metal loop for retaining the metal loop to the brackets. The hardened metal loop further includes a pivot pin for assisting in the installation and removal of the tree stand lock from a tree stand, where the pivot pin is made of a hardened metal.

The lockable hardened ends of the present invention compatibly fit onto the ends of the metal loop and releaseably secure the metal loop to the tree stand. The lockable hardened ends are resistant to cutting or breakage by way of composition and design.

These and other attributes and features of the present invention will be discussed in more detail below.

### BRIEF DESCRIPTION OF THE DRAWINGS

FIG. 1 is an isometric view of a tree stand mounted onto a tree with the tree stand being secured thereto by the tree stand lock of the present invention.

FIG. 2 is an isometric view of the tree stand and the tree stand lock of FIG. 1 shown from a slightly different perspective.

FIG. 3 is a top view of the tree stand lock of the present invention.

FIG. 4 is a front elevational view of the tree stand lock of the present invention.

FIG. 5 is a cross sectional view of a portion of the tree stand lock of FIG. 3 taken along Section Line 5-5.

FIG. 6 is a top view of a portion of the tree stand lock of FIG. 3 showing the pivot pin area of the hardened metal loop.

FIG. 7 is a cross sectional view of a lockable hardened end of the present invention as shown in FIG. 4, and taken along Section Line 7-7.

FIG. 8 is a top view of one half of the hardened metal loop of the present invention.

FIG. 9 is a side elevational view of the half of the hardened metal loop of FIG. 8.

FIG. 10 is a detail side view of the pivot ring end of the half of the hardened metal loop of FIG. 8.

FIG. 11 is a detail front view of the pivot ring end of the half of the hardened metal loop of FIG. 8.

FIG. 12 is a top view of a portion of the half of the hardened metal loop of FIG. 8, showing the front ring end in detail.

FIG. 13 is close-up detail view from the right side of the stand bracket and the end lock as installed on the tree stand.

FIG. 14 is close-up detail view from the left side of the stand bracket and the end lock as installed on the tree stand.

### DETAILED DESCRIPTION OF THE PREFERRED EMBODIMENTS

A novel tree stand lock for securing a tree stand to a tree trunk (or a circumferential body such as a post) is shown in the drawings and is discussed in detail herein. The primary application of the present invention relates to tree stands used for hunting purposes, however, it is understood that the present invention may be adapted to other types of stands, displays, equipment, or other constructions that may be left unattended for periods of time and for which some method for ensuring the security of such property is desired. Where the teachings of the present invention may be extended therefore is generally understood by one skilled in the art and the illustrations and discussions of the uses of the present invention with respect to hunting applications is not meant or intended to be restrictive of the scope of the invention in any way.

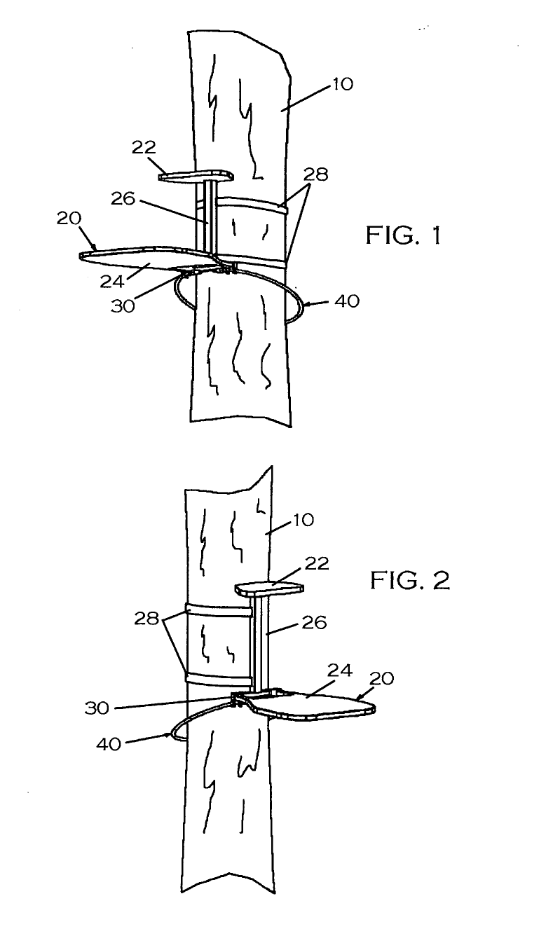

Turning now to FIGS. 1 and 2, a tree stand 20 is mounted onto a tree 10 and includes the seat 22, the base 24, the support 26, and the straps 28. The base 24 further includes the base bracket 30. Securing the tree stand 20 to the tree 10 is the tree stand lock 40.

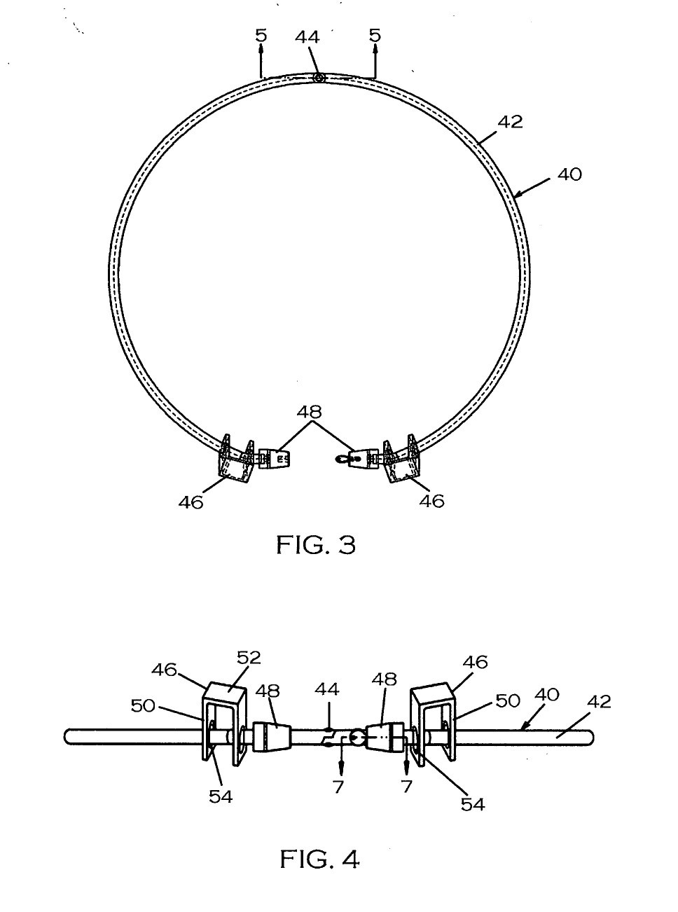

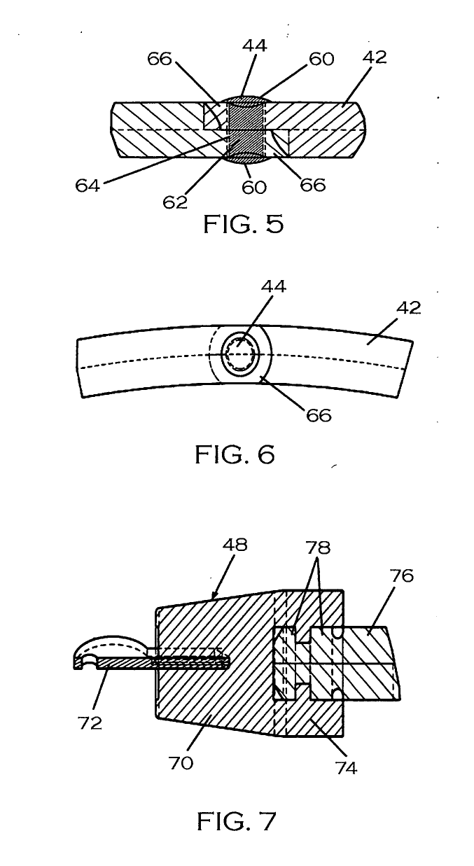

The tree stand lock 40 is shown in more detail in FIGS. 3 and 4, and includes the hardened metal loop 42, the pivot pin 44, the stand bracket portion 46 and the end locks 48. The stand bracket portion 46 includes the bracket sides 50, the bracket top 52 and the bracket hole(s) 54. In FIGS. 5 and 6, the pivot pin 44 is shown in closer detail and includes the pin end(s) 60, the pin body 62, the pin bore 64 all of which are located in the pivot ring end 66. In use, the metal loop 42 pivots about the pivot pin 44 and allows the metal loop 42 to open up to facilitate installation about the tree 10 and then closes to obtain the function of the present invention as described below. It is understood that the hardened metal loop 42 of the present invention is not a closed loop, but sufficiently encircles the circumference of the body to which it is fitted to ensure that the tree stand (in this instance) 20 is secured to the tree 10.

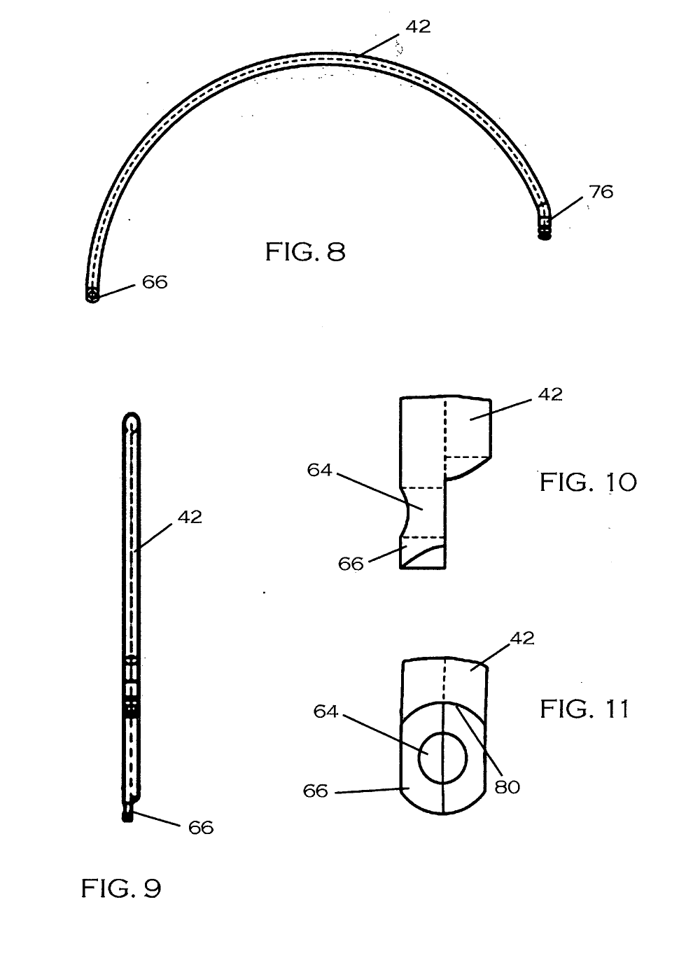

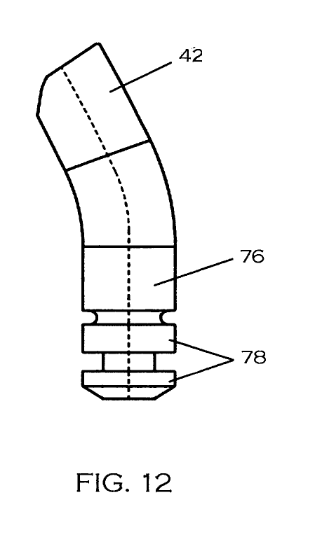

In FIG. 7, an end lock 48 is shown in cross section with the lock body 70, the key 72, the engagement portion 74 and with the front ring end 76 shown as having been inserted into the lock body 70 with front ring lugs 78 fully engaged therein. Continuing on to FIGS. 8, 9, 10 and 11, a portion (half) of the hardened metal loop 42 is shown with the front ring end 76 and the pivot ring end 66. The pivot ring end 66 includes the pin bore 64, and the radius 80. Lastly, the front ring end 76 is shown in detail in FIG. 12 and includes the front ring lugs 78.

As may now be appreciated, the tree stand lock 40 of the present invention is typically applied to a tree stand 20. The actual design type of the tree stand 20 can vary greatly but for purposes of illustrating the use of the present invention, the tree stand 20 depicted in the drawings is basically comprised of a base portion 24 and a seat portion 22 that are interconnected by a support 26. The tree stand 20 can be affixed to a tree 10 by wrapping straps 28 through the support 26 and around the tree 10 and cinching them tightly with buckles or other conventional hardware (not shown). In this manner, the tree stand 20, independent from the tree stand lock 40, will remain mounted to the tree 10 in a useable state.

The tree stand lock 40 is installed by means of the stand bracket portion 46 which is either a component part that may be supplied with the tree stand lock 40, or it may already form a part of the tree stand 20 and is integrally affixed to the stand bracket 30. The stand bracket portion 46 may be welded to the stand bracket 30 or it may be glued, the method being a matter for one skilled in the art of affixing metal components to one another. The stand bracket 30 allows the base 24 to rotate between a stored (folded up) position and a user (folded down) position and is common in the art of tree stand designs. In the stored position the tree stand 20 is made more compact and is thus easier to stow away in a closet, garage or in the bed of a truck or the like. The stand bracket portion 46 is a feature, no matter which way it is supplied, that is permanently welded or affixed to the tree stand 20 itself It is suggested that the area of the stand bracket 30 may be an appropriate place for the stand bracket portion 46, however, it may be installed in any place where it is attached to a substantial part of the tree stand 40 as a whole.

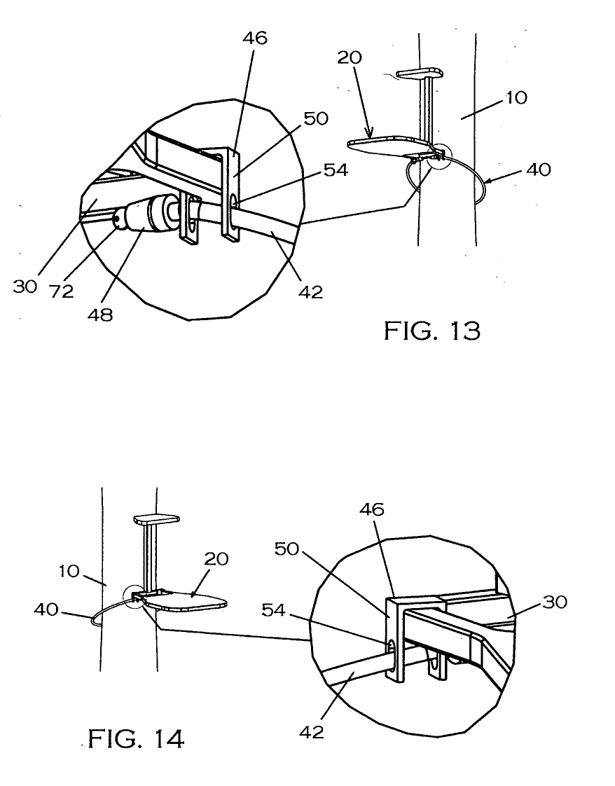

The affixing of the stand bracket portion 46 to the tree stand 20 in a material manner allows for an anchor point for the tree stand lock 40. As can be seen in FIGS. 13 and 14, the tree stand lock 40 relies on the stand bracket portion 46 for linkage to the tree stand 20 and is part of an underlying principle that if a thief clearly desires to remove the tree stand 20, he/she can probably do so however with the present design it will result in a great deal of damage to the tree stand 20, perhaps to the point of ruining the tree stand 20 structurally. Thus when a thief is confronted with the arduous task of ripping through substantial portions of the tree stand 20 in order to remove it, this itself may act as a deterrent, and in the alternative, if the thief continues and does rip through the tree stand 20 to remove it, the subsequent damage to the tree stand 20 will certainly impair its monetary and functional value, thereby creating a disincentive for the thief in the future.

The tree stand lock 40 is comprised of a hardened metal loop 42 which itself is really formed from two complementary halves that are pivotally connected at the pivot pin 44. The metal loop 42 is preferentially circular in shape but it can be configured in any shape that allows it to be connected to the tree stand 20 while being capable to encompass the circumference of the tree 10 at the same time. The metal loop 42 is of hardened steel in the preferred embodiment (although any other hardened metal suitable for resistance against disc grinders and/or bolt cutters and the like could be used as well). The metal loop 42 in the present embodiment forms a ring that encompasses the tree 10 and with two ends (front ring ends 76) that meet in the vicinity of the tree stand 20. The front ring ends 76 can be inserted into the holes 54 in the stand bracket portions 46 which are integrally affixed to the tree stand 20. The end locks 48 are then inserted onto the front ring ends 76 that are protruding through the stand bracket holes 54.

At this point, the end locks 48 engage the front ring lugs 78 and when the key 72 is withdrawn, the end locks 48 automatically lock onto the front ring lugs 78. The resulting assembly cannot be removed and is also uniquely resistant to most of the typical methods that may be used in the field to steal tree stands 20. The metal loop 42 provides no purchase for any cutting instrument and the end locks 48 have hardened cases that are also similarly resistant to attack. The unique design of the present invention repels attempts to remove the tree stand and even if this is accomplished (as described above) the end result may be fruitless. The reason why this approach is so effective is that the prior art methods have relied upon materials that are not hardened and/or installed in ways that can be circumvented with no disincentive to the thief.

The tree stand lock 40 of the present invention may be provided as part of the original equipment of the tree stand 20, or it may be provided as a kit. In the kit form, the stand bracket portions 46 would have to be welded to the tree stand at a location of substance. (The stand bracket portions 46 could also be glued using some of the high strength glues that are now available for metal to metal assembly)

The present invention is illustrated herein for the purposes of teaching the relevant aspects of the tree stand lock 40. The illustration of uses is not meant to be exclusive and the scope of the invention is not meant to be read as being limited to just the teachings herein.

I claim:

1. A lock for retaining an item to a circumferential body such as a tree or a post, where the lock is resistant to removal by unauthorized means, the lock comprising: A hardened metal loop for encircling the body, with lockable ends, and with a pivot point where the hardened metal loop can be opened and closed to facilitate installation of the hardened metal loop onto the body and onto the item; At least one bracket affirmatively affixed to the item; End locks fittable onto the lockable ends of said hardened metal loop, where said end locks are comprised of hardened metal; and, Where the hardened metal loop is installable into said bracket with the lockable ends being compatible with being locked by the end locks and thereafter being securedly retained to the bracket.

2. The lock of claim Number 1, where the pivot point comprises a pivot pin pivotably retained in a pivot bore located on the hardened metal loop, and where the pivot pin is comprised of a hardened metal.

3. The lock of claim Number 1, where the end locks are key locks.

4. The lock of claim Number 1, comprising at least a pair of brackets.

5. A lock for retaining a tree stand to the body of a tree, where the lock is resistant to removal by unauthorized means, the lock comprising:
A hardened metal loop for encircling the body of the tree, with lockable ends, and with a pivot point where the hardened metal loop can be opened and closed to facilitate installation of the hardened metal loop onto the body and onto the tree stand;
At least one bracket affirmatively affixed to the tree stand;
End locks fittable onto the lockable ends of said hardened metal loop, where said end locks are comprised of hardened metal; and,
Where the hardened metal loop is installable into said bracket with the lockable ends being compatible with being locked by the end locks and thereafter being securedly retained to the bracket.

6. The lock of claim Number 5, comprising at least a pair of brackets.

7. The lock of claim Number 5, where the end locks are key locks.

8. The lock of claim Number 5, where the pivot point comprises a pivot pin pivotably retained in a pivot bore located on the hardened metal loop, and where the pivot pin is comprised of a hardened metal.

9. A lock for retaining an item to a circumferential body such as a tree or a post, where the lock is resistant to removal by unauthorized means, the lock comprising:
A hardened metal loop for encircling the body, with lockable ends, and with a pivot point where the hardened metal loop can be opened and closed to facilitate installation of the hardened metal loop onto the body and onto the item, and where the pivot point comprises a pivot pin pivotably retained in a pivot bore located on the hardened metal loop, and where the pivot pin is comprised of a hardened metal;
At least one bracket affirmatively affixed to the item;
End locks fittable onto the lockable ends of said hardened metal loop, where said end locks are comprised of hardened metal; and,
Where the hardened metal loop is installable into said bracket with the lockable ends being compatible with being locked by the end locks and thereafter being securedly retained to the bracket.

10. The lock of claim Number 9, where the end locks are key locks.

11. The lock of claim Number 9, comprising at least a pair of brackets.
